(19) United States
(12) Patent Application Publication
(10) Pub. No.: US 2011/0308445 A1
(43) Pub. Date: Dec. 22, 2011

(54) MEANS AND METHOD FOR CALCULATING, MEASURING AND DISPLAYING A MEASURABLE QUANTITY

(76) Inventor: Shiri Avda, Tel Aviv (IL)

(21) Appl. No.: 13/201,071

(22) PCT Filed: Feb. 15, 2010
(86) PCT No.: PCT/IL10/00133

§ 371 Date: Aug. 11, 2011

Related U.S. Application Data
(60) Provisional application No. 61/152,703, filed on Feb. 15, 2009.

(51) Int. Cl. G01D 13/04; G01D 13/22; G04B 19/04

(52) U.S. Cl. 116/201; 368/228; 116/284

(57) ABSTRACT

The present invention provides a measuring instrument for measuring and displaying a measurable parameter having at least one surface (10), said surface comprising: (a) a pointer pined (30) to said surface, comprising a set of N (numbers for example) symbols disposed along the main longitudinal axis of the same; said N (numbers for example) is an integer greater than or equals to 0; (b) a pre-shaped member (20); (c) means adapted to constantly rotate said elongated pointer (30) around said pre-shaped member (20) on said surface (10) or said pre-shaped member (20) around said elongated pointer (30); wherein said measurable parameter is defined as said N th (numbers/tenth for example) symbol in which an intersection between said pointer (30) with said pre-shaped member (20) is provided.

### FIELD OF THE INVENTION

The present application relates to a new method and device (e.g., watch, a time keeping device) for calculating, measuring and displaying the measurable quantity (e.g., time).

### BACKGROUND OF THE INVENTION

Units of measurement were among the earliest tools invented by humans. Primitive societies needed rudimentary measures for many tasks: constructing dwellings of an appropriate size and shape, fashioning clothing, or bartering food or raw materials. The earliest known uniform systems of weights and measures seem all to have been created at some time in the 4th and 3rd millennia BC among the ancient peoples of Egypt, Mesopotamia and the Indus Valley, and perhaps also Elam (in Iran) as well. Time is part of the measuring system used to sequence events, to compare the durations of events and the intervals between them, and to quantify the motions of objects. Time has been a major subject of religion, philosophy, and science, but defining it in a non-controversial manner applicable to all fields of study has consistently eluded the greatest scholars. A large variety of devices have been invented to measure time. The study of these devices is called horology; or a chronometer (which is a portable timekeeper that meets certain precision standards). There several patents and patent application in said field such as U.S. App. No. 2005/0083787 issued to Perez et al, on Apr. 21, 2005, discloses an object of the “Vertical Time Watch” or a clock, which provides a timepiece that provides a vertically scaled, and therefore linearly graphic, time measurement device, which is both esthetically appealing and easy to read, in addition to its conceptual novelty. The hands, bands, or indicators run along the vertical scales detailed on the dial or face, or along separate lengthwise channels differentiating hours, minutes, seconds, quarter hours, or other time categories. The watch mechanism may be either mechanical (rotating front and back or by resorts), electronic (LCD or other illuminating technology) or any other.

U.S. Pat. No. 6,621,765 discloses a watch that has a digital or analogue time display and a device for displaying Chinese depictions by means of a display element. The display element is provided in particular to display the twelve Chinese life symbols and is designed such that it visually reveals one life symbol in each case for a period of two hours, the respectively visible depiction correlating with a specific time display.

U.S. Pat. No. 6,813,222 (referred to hereinafter as the ‘222’ patent) discloses a watch device that includes two indicators, producing a pattern formed by both indicators, which is either additive (if for example, they are of the same color), or subtractive (if the indicator which is in the foreground has the same color as the background), or combinatory if there are more than three colors. For this purpose, The ‘222’ patent relates to a watch device that includes a motor driving a first rotary hour indicator into rotation at a velocity of 1/N revolutions per hour, and a second rotary minute indicator driven by a concentric axis, characterized in that the minute indicator is driven at a velocity of (N+1)/N revolutions per hour and in that the indicators each have a shape producing a global surface with a variable shape, by covering or juxtaposing the shapes of both needles. Such a realization enables visual effects from variable juxtaposition, superposition and covering of a surface to be produced so that it may be read free from any ambiguity and very succinctly as the exact time may be perceived intuitively in a glance, without having to break down the reading process out into two steps, one for perceiving the hour, the other for perceiving the fractions of an hour. N could be equal to 12 or to 24. Reading the indications is accomplished by estimating the angular difference between both indicators. The indications may be read through generated geometrical conformations according to the relative position of the indicators and allowed by the shape of these indicators. Preferably, a rotary indicator drives a mark for reading indications of the second rotary indicator. These marks are positioned in order to facilitate reading. The mark for reading the indications of the second rotary indicator could be formed by a concentric dial with both indicators, secured to the first hour indicator.

U.S. Pat. No. 4,945,522 discloses a time indicator for a clock or watch that has a watch plate and at least two time-indicating elements that are at least partially superimposed over one another and are driven by centrally and coaxially disposed drive elements. The time-indicating elements are formed by disks or dials that are of the same or different sizes, rotate about centrally disposed shafts, and are disposed in different planes. To indicate time, the dials are provided with openings, indicators, or colors that cover or optically suppress all other information that at any given time is not necessary for reading off that time.

U.S. Pat. No. 5,353,264 (referred to hereinafter as the ‘264’ patent) directed to an improved tide disk apparatus for use in determining the time of condition of tide at a selected time, at a selected location and at a selected date during a selected year, and to a method of calculating the time of the condition with reference to a conventional clock face for a plurality of months employing invention as it is disclosed by the ‘264’ patent. The ‘264’ patent in particular discloses a disk apparatus in combination with a calibration clip apparatus to be calibrated to be in registration with and in reference to a conventional clock face, which is useful in calculating the time of a condition of tide for a plurality of months, typically twelve months, and can also be calibrated to forecast the time of a condition of tide for a plurality of different geographical locations. The ‘264’ patent also discloses an improved tide disk in combination with a calibration clip apparatus for affixation to a disk configured for displaying calendar dates in a spaced apart circular arrangement. The tide disk is of circular construction and characterized by a front display surface of generally flat construction consisting of a thin sheet mounted on the face of the disk for providing a display for a circular arrangement of radially-spaced spiral columns of calendar numerals. The tide disk also includes a back display surface for affixing instructions for use of the Calendar numerals, typically Arabic numerals that are arranged on a series of concentric circles having a center at the central axis of the disk, and includes all the days in each of the 12 months of the year arranged by month. The arrangement of the sequence of calendar numerals numbers typically proceeds from the inside to the outside of the disk, or alternatively may be arranged to proceed from the outer periphery to the central axis according to the wishes of the user.

U.S. Pat. No. 4,692,032 (referred to hereinafter as the ‘032’ patent) discloses a time-keeping apparatus, such as a clock or calendar, which incorporates both analog and digital features. More particularly, the apparatus comprises a rotatable spiral raceway having an inner spiral, an outer spiral, and a plurality of intercommunicating intermediate spirals there between. Means are provided for supporting the raceway in a vertical orientation and for rotating that raceway in a given direction at a given rate (that is, a given number of rotations in a given unit of time). A first indicator means, such as a ball, is mounted within the raceway and adapted for movement relative thereto along the spirals under the influence of gravity as the raceway rotates. The apparatus further comprises a vertically extending set of indicia and means for associating each of the indicia with each of the spirals. Rotation of the raceway causes the first indicator means to be lifted in a straight line from the bottom of the outer spiral to the bottom of the inner spiral, the presence of the first indicator means in a given spiral being a selection of the indicia associated with that spiral. A vertically extending pathway provides communication for the first indicator means between the inner and outer spirals, gravity causing the return of the first indicator means from the end of the inner spiral through the passageway to the beginning of the outer spiral. A second indicator means is preferably mounted on the raceway for rotary movement therewith, the disposition of the second indicator means providing information in addition to that provided by said indicia.

The existing watches known in the art, especially indicator watches (will be referred hereinafter as pointers or watches' hands) suffer from a limitation of unconvinced reading of the exact time. It is therefore a long felt need to provide a more convenient and intuitive measurement instrument in general and time reading watch, in particular, which will be allow an easy and a convenient reading of a measurable parameter in general and time in particular.

### BRIEF DESCRIPTION OF THE INVENTION

The invention is herein described, by way of example only, with reference to the accompanying drawings, wherein:

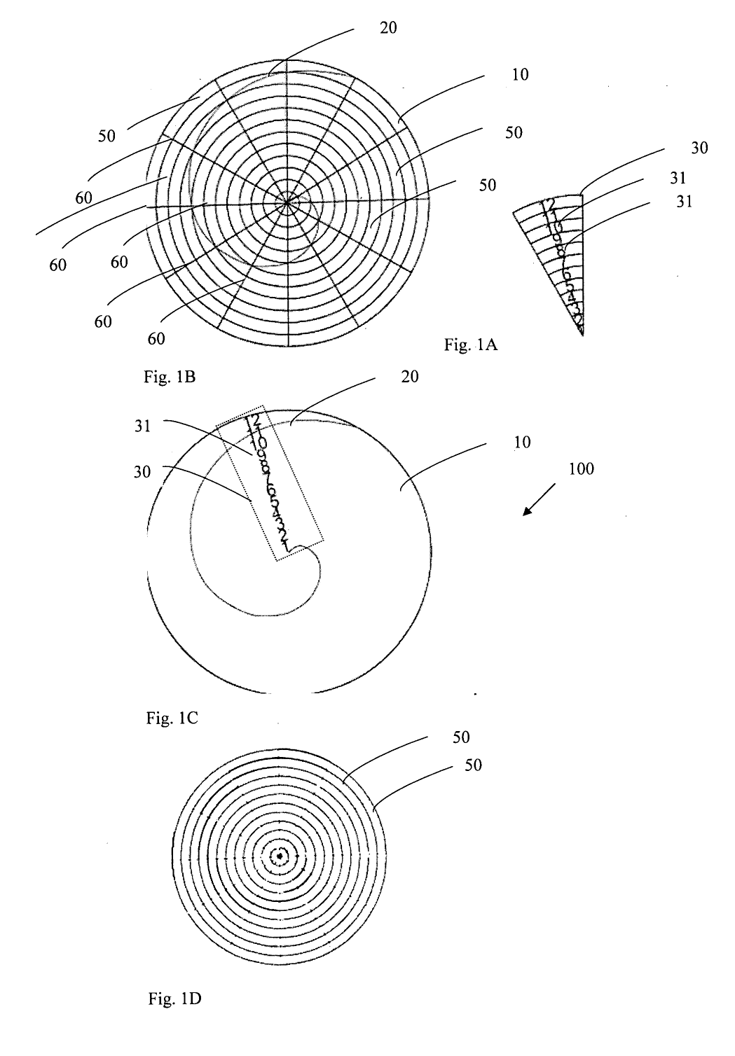

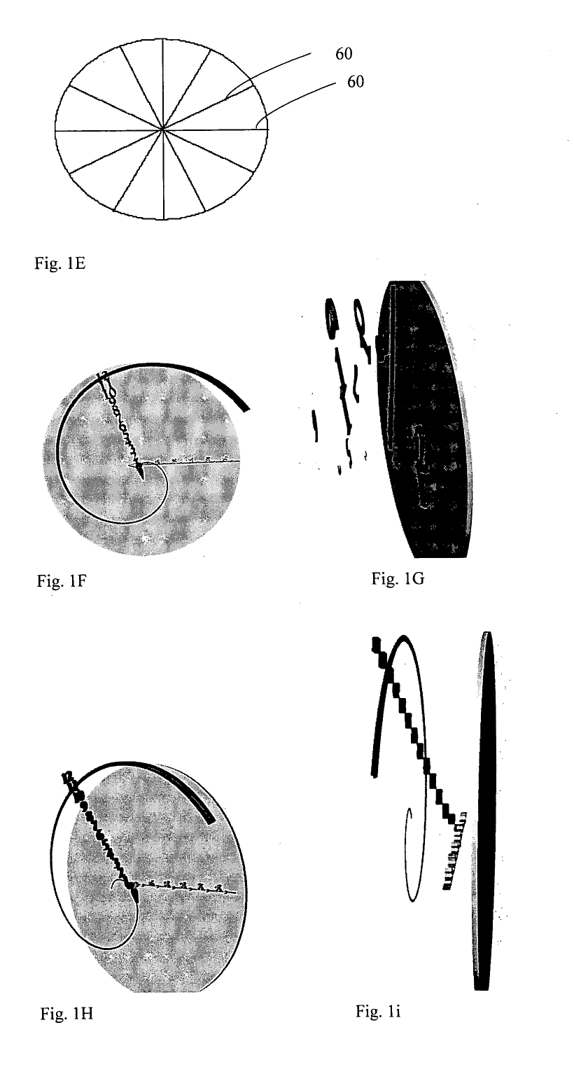

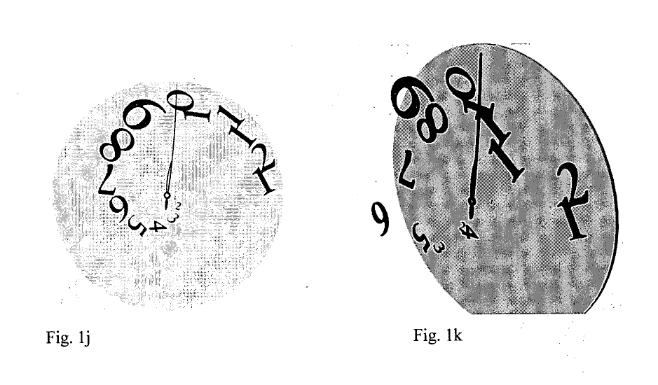

FIGS. 1A-1C illustrating a first embodiment of the watch.

FIGS. 1D-1E illustrate n circles and n slices accordingly; n being 12.

FIGS. 1F-1k illustrate a watch constructed according another embodiment of the present invention (which the numbers on the pointer are in different heights).

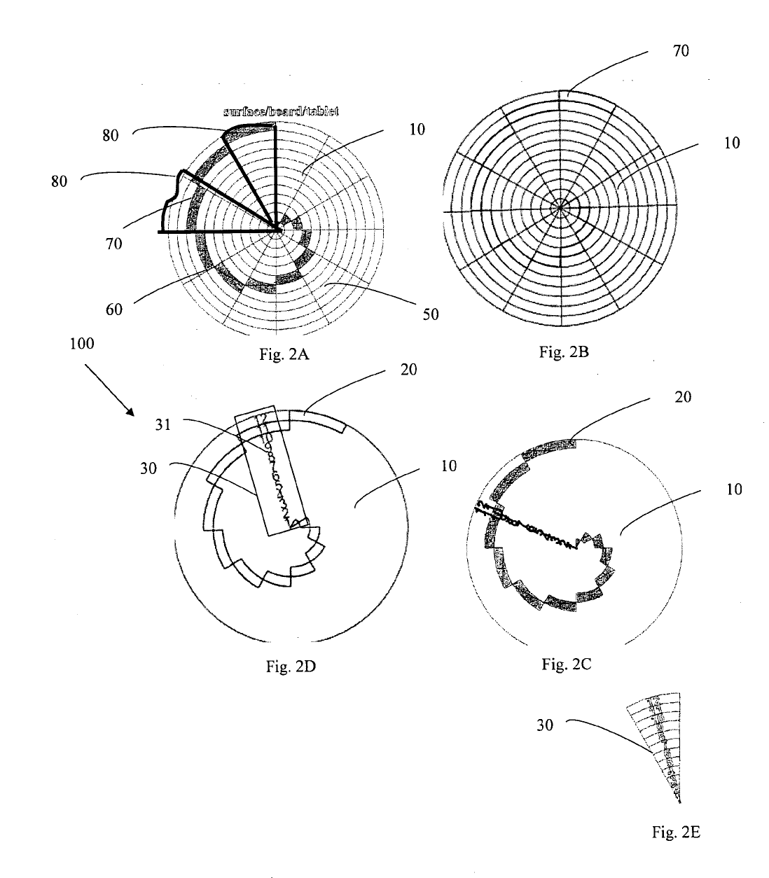

FIGS. 2A-2E illustrate a the watch-face according to a second embodiment of the invention, in which the Time Units are underlined, e.g., by coloring the Time Units, engraving the same of otherwise defining its shape, borders or perimeters.

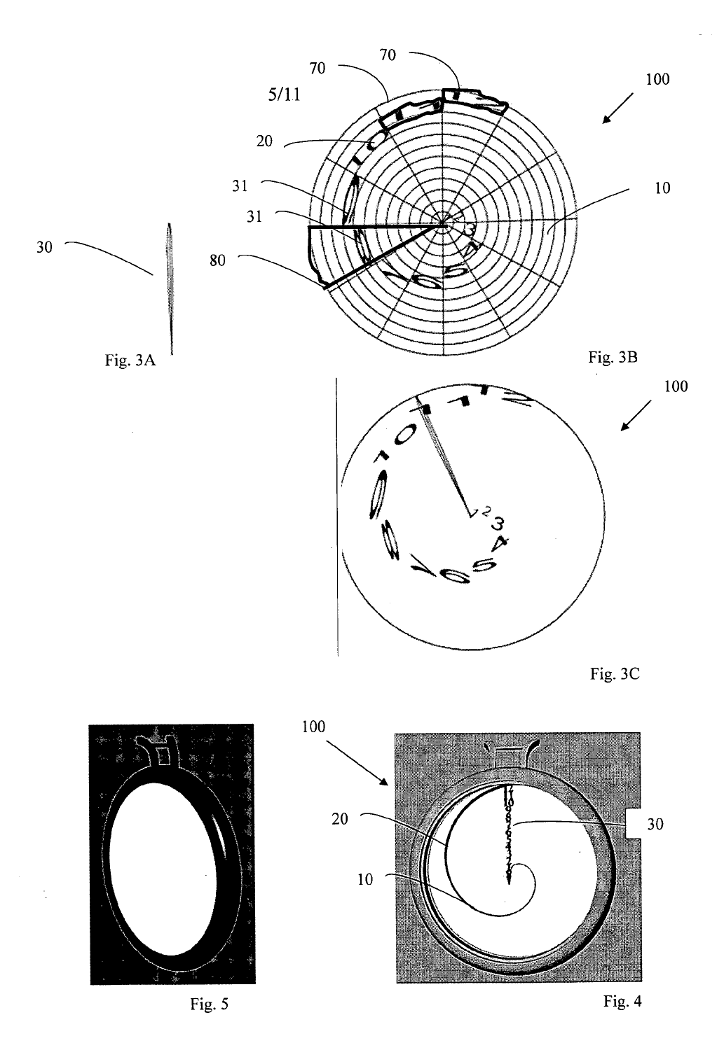

FIGS. 3A-3C which illustrate a watch-face according to third embodiment of the invention, wherein the numbering are disposed on the surface.

FIG. 4 illustrates a front view of one of the embodiments provided by the present invention.

FIG. 5 illustrates a back view of one of the embodiments provided by the present invention.

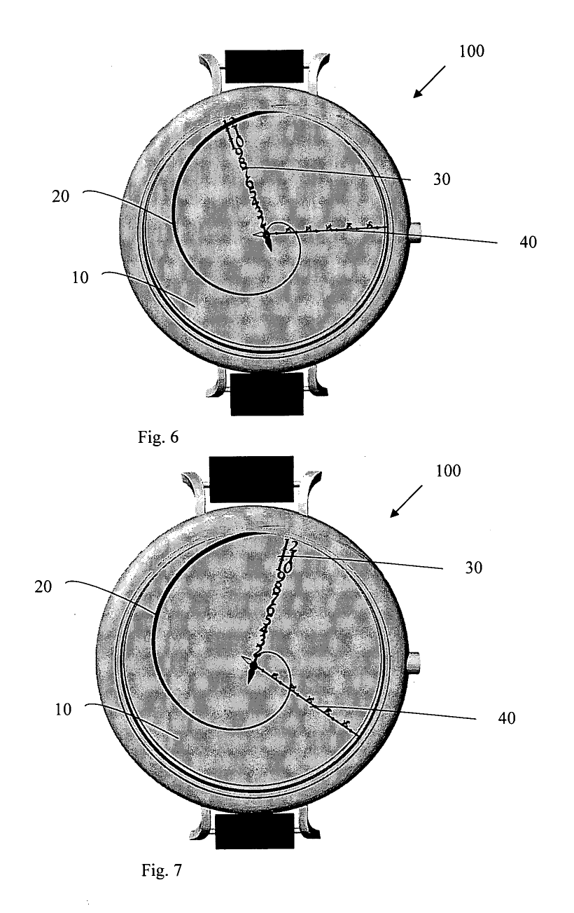

FIGS. 6-9 illustrate a watch 100 in which 2 pointers are utilized.

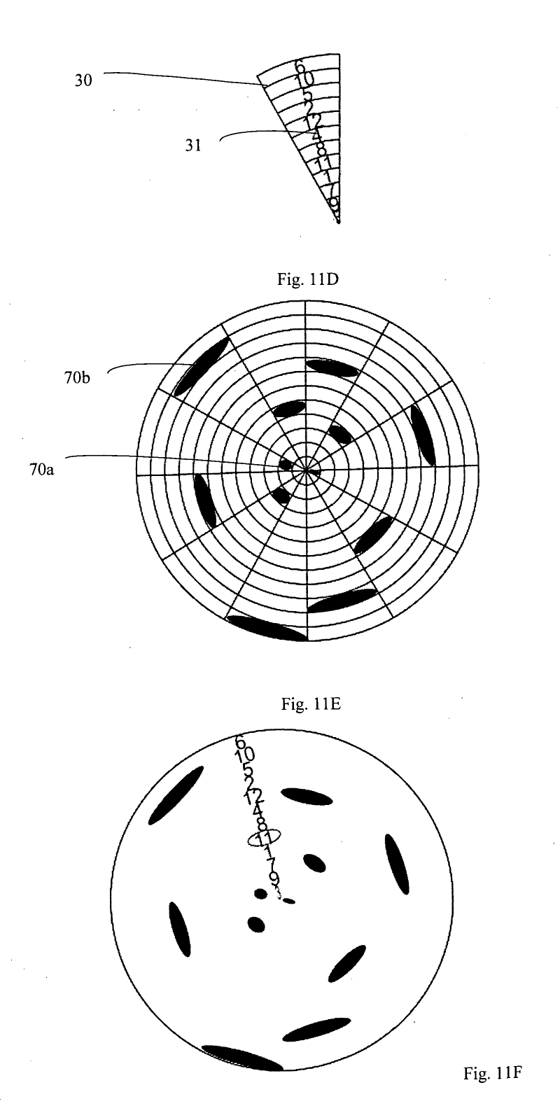

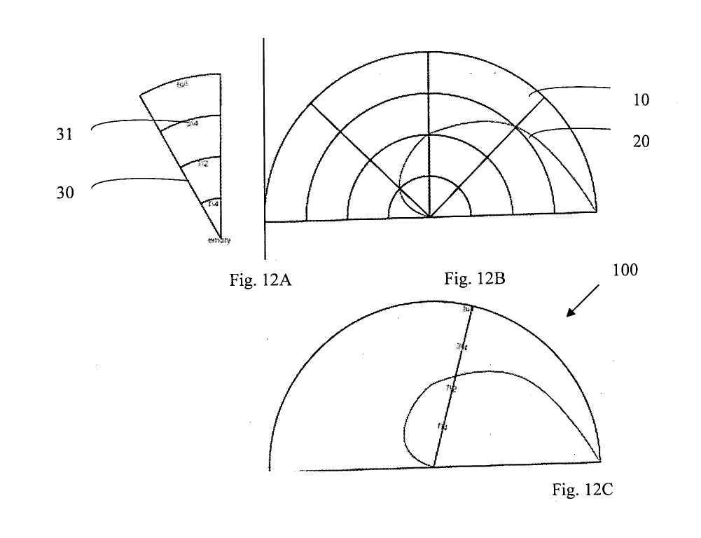

FIGS. 10-11A illustrate a watch 100 in which the pointer (30) does not contain the numbers.

FIGS. 11B-11C illustrate a watch 100 in which the numbers 31 are disposed in an arbitrary pattern. i.e., the shaped of the pre-shaped member 20 is arbitrary.

FIGS. 11D-11F illustrate a watch in which the numbering 31 on the pointer 30 are not sequential.

FIGS. 12A-12C illustrate a liquid measuring instrument.

### SUMMARY OF THE INVENTION

It is one object of the present invention to provide a measuring instrument 100 for measuring and displaying a measurable parameter, said measuring instrument having at least one surface 10, said surface comprising:
a. at least one elongated pointer 30 characterized by a main longitudinal axis having a distal end and a proximal end; said pointer is pin to said surface in either said distal end or said proximal end; said pointer comprises a set of n symbols 31 disposed along said main longitudinal axis; said n is an integer greater than or equals to 0;
b. a pre-shaped member 20 characterized by a predetermined curvature;
c. means adapted to constantly rotate said elongated pointer around said pre-shaped member on said surface or said pre-shaped member around said elongated pointer;
wherein said measurable parameter is defined as said n^{th} symbol in which an intersection between said pointer with said pre-shaped member is provided.

It is another object of the present invention to provide the measuring instrument as defined above, wherein said pre-shaped member 20 is characterized by a spiral-like shaped, arbitrary shape, circle-like shape, square shape or any combination thereof.

It is another object of the present invention to provide the measuring instrument as defined above, wherein said measurable parameter is selected from a group consisting of time, temperature, quantities measurements (weight, mass), pressure measurements, altitude measurements, intensity or any combination thereof.

It is another object of the present invention to provide the measuring instrument as defined above, wherein said measuring instrument is selected from a group consisting of watch, time keeping device, thermostat, weight, pressure gauge, barometer, altimeter or any combination thereof.

It is another object of the present invention to provide the measuring instrument as defined above, wherein said displaying is selected from a group consisting of a mechanical display, digital display in either a 2 dimensional or 3 dimensional display or any combination thereof.

It is another object of the present invention to provide the measuring instrument as defined above, wherein said symbol is selected from a group consisting of digits, letters, words, figures or any combination thereof.

It is another object of the present invention to provide the measuring instrument as defined above, wherein said pre-shaped member 20 is embedded within said surface 10.

It is another object of the present invention to provide the measuring instrument as defined above, wherein said means are adapted to constantly rotate said pre-shaped member embedded within said surface around said elongated pointer.

It is another object of the present invention to provide the measuring instrument as defined above, wherein said n symbols are interchangeable such that the position of each symbols is altered.

It is another object of the present invention to provide the measuring instrument as defined above, wherein said n symbols are selected from a group consisting of integer numbers, real numbers, chars, strings or any combination thereof.

It is another object of the present invention to provide the measuring instrument as defined above, wherein said n symbols are integers.

It is another object of the present invention to provide the measuring instrument as defined above, wherein said n symbols are positioned on said pointer in either a sequential or a non sequential manner.

It is another object of the present invention to provide the measuring instrument as defined above, wherein the shape of said surface is selected from a group consisting of any geometrical shape, amorphous shape or any combination thereof.

It is another object of the present invention to provide a method for measuring a measurable parameter. The method comprising steps of selected inter alia from:
a. obtaining a measuring instrument 100 having at least one surface, said surface 10 comprising:
   i. at least one elongated pointer 30 characterized by a main longitudinal axis having a distal end and a proximal end; said pointer is pin to said surface in either said distal end or said proximal end; said pointer comprises a set of n symbols 31 disposed along said main longitudinal axis; said n is an integer greater than or equals to 0;
   ii. a pre-shaped member 20 characterized by a predetermined curvature;
   iii. means adapted to constantly rotate said elongated pointer around pre-shaped member on said surface or said pre-shaped member around said elongated pointer;
b. identifying the intersection point between said pointer and said pre-shaped member;
c. defining said measurable parameter as said n^{th} symbol in said intersection; thereby measuring said measurable parameter.

It is another object of the present invention to provide the method as defined above, additionally comprising step of selecting said measurable parameter from a group consisting of time, temperature, quantities measurements (weight, mass), pressure measurements, altitude measurements, intensity or any combination thereof.

It is another object of the present invention to provide the method as defined above, additionally comprising step of selecting said measuring instrument from a group consisting of watch, time keeping device, thermostat, weight, pressure gauge, barometer, altimeter or any combination thereof.

It is another object of the present invention to provide the method as defined above, additionally comprising step of displaying said measurable parameter.

It is another object of the present invention to provide the method as defined above, additionally comprising step of selecting said displaying from a group consisting of a mechanical display, digital display in either a 2 dimensional or 3 dimensional display or any combination thereof.

It is another object of the present invention to provide the method as defined above, additionally comprising step of selecting said symbol from a group consisting of digits, letters, words, figures or any combination thereof.

It is another object of the present invention to provide the method as defined above, additionally comprising step of embedding said pre-shaped member 20 within said surface 10.

It is another object of the present invention to provide the method as defined above, additionally comprising step of constantly rotating said pre-shaped member embedded within said surface around said elongated pointer.

It is another object of the present invention to provide the method as defined above, additionally comprising step of constantly rotating said elongated pointer around said pre-shaped member on said surface around.

It is another object of the present invention to provide the method as defined above, additionally comprising step of interchanging said n symbols such that the position of each symbols is altered.

It is another object of the present invention to provide the method as defined above, additionally comprising step of selecting the shape of said pre-shaped member 20 from a group consisting of spiral-like shaped, arbitrary shape, circle-like shape, square shape or any combination thereof.

It is another object of the present invention to provide the method as defined above, additionally comprising step of selecting said n symbols from a group consisting of integer numbers, real numbers, chars, strings or any combination thereof.

It is another object of the present invention to provide the method as defined above, additionally comprising step of positioning said n symbols on said pointer in either a sequential or a non sequential manner.

It is another object of the present invention to provide a measuring instrument 100 for measuring and displaying a measurable parameter, said measuring instrument having at least one surface 10, said surface comprising:
a. at least one pre-shaped member 20 characterized by a predetermined curved shape; said pre-shaped member is pined to said surface; said pre-shaped member comprises a set of n symbol 31 disposed along said curved shape; said n is an integer greater than or equals to 0;
b. at least one elongated pointer 30 characterized by a main longitudinal axis;
c. means adapted to constantly rotate said elongated pointer around said pre-shaped member 20 on said surface 10 or said pre-shaped member around said elongated pointer;
wherein said measurable parameter is defined as said n^{th} symbol in which an intersection between said pointer with said pre-shaped member is provided.

It is another object of the present invention to provide the measuring instrument as defined above, wherein said measurable parameter is selected from a group consisting of time, temperature, quantities measurements (weight, mass), pressure measurements, altitude measurements, intensity or any combination thereof.

It is another object of the present invention to provide the measuring instrument as defined above, wherein said pre-shaped member 20 is characterized by a spiral-like shaped, arbitrary shape, circle-like shape, square shape or any combination thereof.

It is another object of the present invention to provide the measuring instrument as defined above, wherein said measuring instrument is selected from a group consisting of watch, time keeping device, thermostat, weight, pressure gauge, barometer, altimeter or any combination thereof.

It is another object of the present invention to provide the measuring instrument as defined above, wherein said displaying is selected from a group consisting of a mechanical display, digital display in either a 2 dimensional or 3 dimensional display or any combination thereof.

It is another object of the present invention to provide the measuring instrument as defined above, wherein said symbol is selected from a group consisting of digits, letters, words, figures or any combination thereof.

It is another object of the present invention to provide the measuring instrument as defined above, wherein said pre-shaped member 20 is embedded within said surface 10.

It is another object of the present invention to provide the measuring instrument as defined above, wherein said means are adapted to constantly rotate said pre-shaped member embedded within said surface around said elongated pointer.

It is another object of the present invention to provide the measuring instrument as defined above, wherein said n symbols are interchangeable such that the position of each symbols is altered.

It is another object of the present invention to provide the measuring instrument as defined above, wherein said n symbols are selected from a group consisting of integer numbers, real numbers, chars, strings or any combination thereof.

It is another object of the present invention to provide the measuring instrument as defined above, wherein said n symbols are integers.

It is another object of the present invention to provide the measuring instrument as defined above, wherein said n symbols are positioned on said pointer in either a sequential or a non sequential manner.

It is another object of the present invention to provide the measuring instrument as defined above, wherein the shape of said surface is selected from a group consisting of any geometrical shape, amorphous shape or any combination thereof.

It is another object of the present invention to a method for measuring a measurable parameter. The method comprising steps selected inter alia from:
a. obtaining a measuring instrument 100 having at least one surface 10, said surface comprising:
   i. at least one pre-shaped member 20 characterized by a predetermined curved shape; said pre-shaped member is pined to said surface; said pre-shaped member comprises a set of n symbols 31 disposed along said curved shape; said n is an integer greater than or equals to 0;
   ii. at least one elongated pointer 30 characterized by a main longitudinal axis;
   iii. means adapted to constantly rotate said elongated pointer around said pre-shaped member on said surface 10 or said pre-shaped member around said elongated pointer;
b. indentifying the intersection point between said pointer and said pre-shaped member;
c. defining said measurable parameter as said n^{th} symbol in said intersection; thereby measuring said measurable parameter.

It is another object of the present invention to provide the method as defined above, additionally comprising step of selecting said measurable parameter from a group consisting of time, temperature, quantities measurements (weight, mass), pressure measurements, altitude measurements, intensity or any combination thereof.

It is another object of the present invention to provide the method as defined above, additionally comprising step of selecting the shape of said pre-shaped member 20 from a group consisting of spiral-like shaped, arbitrary shape, circle-like shape, square shape or any combination thereof.

It is another object of the present invention to provide the method as defined above, additionally comprising step of selecting said n symbols from a group consisting of integer numbers, real numbers, chars, strings or any combination thereof.

It is another object of the present invention to provide the method as defined above, additionally comprising step of positioning said n symbols on said pointer in either a sequential or a non sequential manner.

It is another object of the present invention to provide the method as defined above, additionally comprising step of selecting said measuring instrument from a group consisting of watch, time keeping device, thermostat, weight, pressure gauge, barometer, altimeter or any combination thereof.

It is another object of the present invention to provide the method as defined above, additionally comprising step of displaying said measurable parameter.

It is another object of the present invention to provide the method as defined above, additionally comprising step of selecting said displaying from a group consisting of a mechanical display, digital display in either a 2 dimensional or 3 dimensional display or any combination thereof.

It is another object of the present invention to provide the method as defined above, additionally comprising step of selecting said symbol from a group consisting of digits, letters, words, figures or any combination thereof.

It is another object of the present invention to provide the method as defined above, additionally comprising step of embedding said pre-shaped member 20 within said surface 10.

It is another object of the present invention to provide the method as defined above, additionally comprising step of constantly rotating said pre-shaped member embedded within said surface around said elongated pointer.

It is another object of the present invention to provide the method as defined above, additionally comprising step of constantly rotating said elongated pointer around said pre-shaped member on said surface around.

It is another object of the present invention to provide the method as defined above, additionally comprising step of interchanging said n symbols such that the position of each symbols is altered.

It is another object of the present invention to a time keeping device 100 for displaying the time having at least one surface 10, said surface comprising:
a. at least one elongated pointer 30 characterized by a main longitudinal axis having a distal end and a proximal end; said pointer is pin to said surface in either said distal end or said proximal end; said pointer comprises a set of at least 12 numbers 31 disposed along said main longitudinal axis; each of said numbers represents parameters selected from a group consisting of hours, minutes, seconds or any combination thereof;
b. at least one pre-shaped member 20 characterized by a predetermined curvature;
c. means adapted to constantly rotate said elongated pointer around said pre-shaped member on said surface or said pre-shaped member around said elongated pointer;
wherein said time is calculated from the intersection of said pointer with said pre-shaped member.

It is another object of the present invention to provide the time keeping device as defined above, wherein the shape of said surface is selected from a group consisting of any geometrical shape, amorphous shape or any combination thereof. It is another object of the present invention to provide the time keeping device as defined above, wherein said pre-shaped member 20 is characterized by a spiral-like shaped, arbitrary shape, circle-like shape, square shape or any combination thereof.

It is another object of the present invention to provide the time keeping device as defined above, wherein said numbers 31 are positioned on said pointer in either a sequential or a non sequential manner.

It is another object of the present invention to provide the time keeping device as defined above, wherein said pre-shaped member 20 is embedded within said surface 10.

It is another object of the present invention to provide the time keeping device as defined above, wherein said means are adapted to constantly rotate said pre-shaped member embedded within said surface around said elongated pointer.

It is another object of the present invention to provide the time keeping device as defined above, wherein said displaying is selected from a group consisting of a mechanical display, digital display in either a 2 dimensional or 3 dimensional display or any combination thereof.

It is another object of the present invention to provide the time keeping device as defined above, wherein said pre-shaped member 20 is embedded within said surface 10.

It is another object of the present invention to provide the time keeping device as defined above, wherein said means are adapted to constantly rotate said pre-shaped member embedded within said surface around said elongated pointer.

It is another object of the present invention to provide the time keeping device as defined above, wherein said n numbers are interchangeable such that the position of each symbols is altered.

It is another object of the present invention to provide a method for calculating the time. The method comprising steps selected inter alia from:
a. obtaining a time keeping device 100 having at least one surface 10, said surface comprising:
   i. at least one elongated pointer 30 characterized by a main longitudinal axis having a distal end and a proximal end; said pointer is pin to said surface in either the distal end or the proximal end; said pointer comprises a set of at least 12 numbers 31 disposed along said main longitudinal axis; each of said numbers represents parameters selected from a group consisting of hours, minutes, seconds or any combination thereof;
   ii. a pre-shaped member 20 characterized by a predetermined curvature;
   iii. means adapted to constantly rotate said elongated pointer around said pre-shaped member on said surface or said pre-shaped member around said elongated pointer;
b. identifying the intersection point between said pointer and said pre-shaped member, thereby calculating the time.

It is another object of the present invention to provide a time keeping device 100 for displaying the time having at least one surface 10, said surface comprising:
a. at least one pre-shaped member 20 characterized by a predetermined curved shape; said pre-shaped member is pined to said surface; said pre-shaped member comprises a set of at least 12 numbers 31 disposed along said curved shape; each of said numbers represents parameters selected from a group consisting of hours, minutes, seconds or any combination thereof;
b. at least one elongated pointer 30 characterized by a main longitudinal axis;
c. means adapted to constantly rotate said elongated pointer around said pre-shaped member on said surface or said pre-shaped member around said elongated pointer;
wherein said time is calculated from the intersection of said pre-shaped member with said pointer.

It is another object of the present invention to provide the time keeping device as defined above, wherein the shape of said surface is selected from a group consisting of any geometrical shape, amorphous shape or any combination thereof.

It is another object of the present invention to provide the time keeping device as defined above, wherein said pre-shaped member 20 is characterized by a spiral-like shaped, arbitrary shape, circle-like shape, square shape or any combination thereof.

It is another object of the present invention to provide the time keeping device as defined above, wherein said pre-shaped member 20 is embedded within said surface 10.

It is another object of the present invention to provide the time keeping device as defined above, wherein said means are adapted to constantly rotate said pre-shaped member embedded within said surface around said elongated pointer.

It is another object of the present invention to provide the time keeping device as defined above, wherein said displaying is selected from a group consisting of a mechanical display, digital display in either a 2 dimensional or 3 dimensional display or any combination thereof.

It is another object of the present invention to provide the time keeping device as defined above, wherein said pre-shaped member 20 is embedded within said surface 10.

It is another object of the present invention to provide the time keeping device as defined above, wherein said means are adapted to constantly rotate said pre-shaped member embedded within said surface around said elongated pointer.

It is still object of the present invention to provide the time keeping device as defined above, wherein said n numbers are interchangeable such that the position of each symbols is altered.

It is another object of the present invention to provide the time keeping device as defined above, wherein said numbers are positioned on said pointer in either a sequential or a non sequential manner.

It is another object of the present invention to provide a method for calculating the time. The method comprising steps selected inter alia form:
a. obtaining a time keeping device 100 having at least one surface 10, said surface comprising:
   i. at least one pre-shaped member 20 characterized by a predetermined curved shape; said pre-shaped member 20 is pin to said surface in at least one point to said surface; said pre-shaped member comprises a set of at least 12 numbers 31 disposed along said curved shape; each of said numbers represents parameters selected from a group consisting of hours, minutes, seconds or any combination thereof;
   ii. at least one elongated pointer 30;
   iii. means adapted to constantly rotate said elongated pointer around said pre-shaped member on said surface 10 or said pre-shaped member around said elongated pointer;
b. identifying the intersection point between said pointer and said pre-shaped member, thereby calculating the time.

It is another object of the present invention to provide a method for providing a measuring instrument for measuring a measurable parameter characterized by n measurable units. The method comprising steps selected inter alia from:
(a) obtaining a surface;
(b) dividing said surface into n coaxial cycles;
(c) slicing said surface into n slices; thereby obtaining n triangles on said surface; each of said n triangles is characterized by n cells created by said n cycles positioned within each two neighboring slices;
(d) providing a pointer;
(e) disposing said n measurable units on said pointer; thereby providing said measuring instrument.

It is another object of the present invention to provide the method as defined above, additionally comprising step of measuring measurable parameter by (i) identifying the intersection point between said pointer and said highlighted cell; and, (ii) defining said measurable parameter as said n^{th} measurable units in said intersection; thereby measuring said measurable parameter.

It is still an object of the present invention to provide a method for providing a measuring instrument for measuring a measurable parameter characterized by n measurable units. The method comprises steps selected inter alia from:
(a) obtaining a surface;
(b) dividing said surface into n coaxial cycles;
(c) slicing said surface into n slices; thereby obtaining n triangles on said surface; each of said n triangles is characterized by n cells created by said n cycles positioned within each two neighboring slices;
(d) providing a pointer;
(e) disposing each of said n measurable units in n cell, each of which is positioned in a different triangle following either a predetermined shape or in an arbitrary shape; thereby providing said measuring instrument.

It is lastly an object of the present invention to provide the method as defined above, additionally comprising step of measuring measurable parameter by (i) identifying the intersection point between said pointer and said highlighted cell; and, (ii) defining said measurable parameter as said n^{th} measurable units in said intersection; thereby measuring said measurable parameter.

### DETAIL DESCRIPTION OF THE INVENTION

The following description is provided, alongside all chapters of the present invention, so as to enable any person skilled in the art to make use of the invention and sets forth the best modes contemplated by the inventor of carrying out this invention. Various modifications, however, is adapted to remain apparent to those skilled in the art, since the generic principles of the present invention have been defined specifically to provides a calculation method/mathematic formula, for measuring a measurable element.

The present invention provides a measuring instrument for measuring and displaying a measurable parameter, said measuring instrument having at least one surface. The surface comprises (a) at least one elongated pointer characterized by a main longitudinal axis having a distal end and a proximal end; said pointer is pin to said surface in either said distal end or said proximal end; said pointer comprises a set of n symbol disposed along said main longitudinal axis; said n is an integer greater than or equals to 0; said elongated pointer is adapted to constantly circulate around said surface; and, (b) a pre-shaped member (e.g., spiral-like); said pre-shaped member is characterized by a predetermined curvature.

It should be pointed that the measurable parameter is calculated/defined as said n^{th} symbol in which said pointer intersects said pre-shaped member.

The present invention further provides a measuring instrument for measuring and displaying a measurable parameter, said measuring instrument having at least one surface. The surface comprises (a) at least one pre-shaped member (e.g., spiral-like) characterized by a predetermined curved shape; said pre-shaped member is pined to said surface; said pre-shaped member comprises a set of n symbol disposed along said curved shape; said n is an integer greater than or equals to 0; and, (b) at least one elongated pointer characterized by a main longitudinal axis, adapted to constantly circulate around said surface.

It is emphasized that the measurable parameter is calculated/defined as said n^{th} symbol in which said pointer intersects said pre-shaped member.

The present invention also provides various methods for measuring the measurable parameter.

The term “measuring instrument” refers hereinafter to a device which can estimate of the magnitude of some attribute of an object, such as its length or weight, pressure, amount, time, relative to a unit of measurement.

The term “indicator watches” or “watches hands” or “pointer” refers hereinafter to a part of a clock's face. The clock face is the part of an analog clock (or watch) that displays the time through the use of a fixed numbered dial or dials and moving hands. In its most basic form, recognized universally throughout the world, the dial is numbered 1-12 indicating the hours in a 12-hour cycle, and a short hour hand makes 2 revolutions in a day. A longer minute hand makes one revolution every hour. The face may also include a second hand which makes one revolution per minute, and other hands. The term is less commonly used for the time display on digital clocks and watches.

According to the present invention, the pre-shaped member is characterized by a spiral-like shaped, arbitrary shape, circle-like shape, square shape or any combination thereof.

According to the present invention the pointer is used to indicate what the calculated measurable parameter is.

According to one embodiment of the present invention the measurable parameter is selected from a group consisting of time, temperature, quantities measurements (weight, mass), pressure measurements, altitude measurements, intensity or any combination thereof.

According to another embodiment of the present invention, the measuring instrument is selected from a group consisting of watch, thermostat, weight, pressure gauge, barometer, altimeter or any combination thereof.

According to another embodiment of the present invention, said n symbols are selected from a group consisting of integer numbers, real numbers, chars, strings or any combination thereof.

According to another embodiment of the present invention, said n symbols are positioned on said pointer/said pre-shaped member in either a sequential or a non sequential manner

According to another embodiment of the present invention, the measuring instrument is adapted to display said measurable parameter either in a mechanical display, digital display or any combination thereof.

According to another embodiment of the present invention, said symbol is selected from a group consisting of digits, letters, words, figures or any combination thereof.

### First Embodiment

### Time Calculating and Displaying Means—Watch

As described above, according to one embodiment of the present invention, the measuring instrument is a watch and the measurable parameter is time. The following description is merely an example and relates to said specific embodiment in which the measuring instrument is a watch and the measurable parameter is time.

It should be emphasized, however, that the measuring instrument can be any measuring instrument adapted to measure any measurable parameter known.

As described above, the watch provided by the present invention has at least one surface. The surface comprising (a) at least one elongated pointer characterized by a main longitudinal axis having a distal end and a proximal end; said pointer is pin to said surface in either said distal end or said proximal end; said pointer comprises a set of at least 12 numbers disposed along said main longitudinal axis; each of said numbers represents parameters selected from a group consisting of hours, minutes, seconds or any combination thereof; said elongated pointer is adapted to constantly circulate around said surface; and, (b) a static pre-shaped member (e.g., spiral-like member).

The said time is calculated from the intersection of said pointer with said pre-shaped member on the clock surface (refers hereinafter also as board or tablet).

In FIGS. 1-10 the pre-shaped member is illustrated as a spiral-like member the following description will refer to the pre-shaped member as a spiral-like member.

Reference is now made to FIGS. 1A-1C illustrating a first embodiment of the watch. FIG. 1A illustrates the pointer 30. It should be further pointed that in said embodiment the pointer is basically the clock's hand. According to said embodiment the pointer comprises a set of at least 12 numbers (illustrated as numerical reference 31) disposed along the main longitudinal axis of the pointer 30.

Each of said numbers 31 represents parameters selected from a group consisting of hours, minutes, seconds or any combination thereof. In other words, if said numbers 31 represents the hours, thus said pointer 30 is an hour hand; if said numbers 31 represents the minutes, thus said pointer 30 is a minutes hand; if said numbers 31 represents the seconds, thus said pointer 30 the seconds hand.

FIG. 1B illustrates the surface 10 upon which the static spiral-like member 20 is present.

Reference is now made to FIG. 1C combining the pointer with the static spiral-like member 20 on the surface 10.

As described above, the elongated pointer 30 is adapted to constantly circulate around said surface 10.

The time is indicated from the intersection point between the pointer and the static spiral-like member 20. For example, the time represented in FIG. 1C is 11.

It should be emphasized that more than one pointer can be provided (as can be seen in FIGS. 6-9).

The method of time measuring and watch provided by the present application can be utilized in either pointers or digital clocks/watches.

As described above, the present invention provides a visual chronology interface of a timekeeping device.

The interface includes visual time indicator means, such as a spherical watch face (i.e., the surface) and an elongated hour hand (i.e., the pointer) both installed in the timekeeping device in a conventional manner known in the art.

The elongated hour hand (i.e., the pointer) carries a set of at least twelve numerals, where each numeral represents one of the twelve hours typically shown by most of the existing chronology devices on the planet. Alternatively the pointer can be minutes hand or seconds hand, in which case it will contain a set of 60 numbers.

The numerals are sequentially and orderly disposed on upper surface of the pointer along the horizontal axis thereof where the numeral ‘1’ is placed in a position nearest to the center of the spherical watch face (i.e., the surface 10) and the numeral ‘12’ is placed in a position nearest to the circumference of the spherical watch face. The hour hand is rotated in a conventional manner (sweeping along the surface of the watch face in a clockwise direction) by a conventional timekeeping analog and/or electronic mechanism of the chronology device, as known in the art.

The watch face is not graduated by numerals but includes (according to one embodiment) a static background area and a static spiral-like foreground area.

According to one embodiment, the static background area has no indicia, tic markings, symbols or graphical indicators; it covers entirely the surface of the watch face.

The static background area is designed as a spiral display (i.e., the static spiral-like member 20) suitably disposed on the background area. The spiral starts at an inner tip or starting point, located in near proximity to the center of the spherical watch face (i.e., surface 10).

The spiral then follows a helical path up to the outer tip or termination point, located near at the periphery of the spherical watch face.

The background display and the spiral display are fully integrated into the watch face display.

As illustrated and described above, the two-dimensional spatial relationship of the hour hand (i.e., the pointer) and the spiral is designed such that the approximate hour of the day is indicated graphically by a numeral approximately superimposed on a point of the spiral, which point is characterized by being the location where the static spiral display and the rotating hour hand (i.e. the pointer), carrying the numeral, intersect momentarily at the given point in time (as can be seen in FIG. 1C, in which the hour is 11).

The calculation method—in order to calculate a time unit (hour, minute, second, 10 minutes, 15 minutes, etc.) the surface of the clock is divided twice:

(a) concentric/coaxial circles positioned in equal gaps; FIG. 1D demonstrates for examples a surface containing 12 circles (illustrated as numerical reference 50). Also represented as numerical reference 50 in FIGS. 1B and 2B.
(b) segment the surface of the clock to equal slices; FIG. 1E demonstrates for examples a surface containing 12 slices (illustrated as numerical reference 60). Also represented as numerical reference 60 in FIG. 2B.

The double division (circles and slices) will create time-units/time-boxes.

Each time unite represent a unit of time, which contain/consist the same amount of time.

The number of circles and the number of slices must be equal. This number is determined by the unit of time wanted to be measured. For example:
1. time units of 12 hours—there will be 12 circles and 12 slices. For example, in FIGS. 1B, 2A, 3B there are 12 circles and 12 slices.
2. time units of 60 minutes—there will be 60 circles and 60 slices.
3. time units of 10 minutes (from 1 hour/60 minutes)—there will be 6 circles and 6 slices.
4 time units of ¼ hour (from 1 hour/60 minutes)—there will be 4 circles and 4 slices.

After the surface 10 had been ‘sliced’ and the circles have been drawn on the same, n triangles are created (see numerical reference 80 in FIGS. 2A, 3B). n equals the number of circles and slices. For example, in FIG. 3B 12 triangles are created.

Each triangle 80 comprises n cells (each of said cells will be referred to as Time Units). The Time Units are highlighted in a darker color in FIG. 2A and illustrated as numerical reference 70 in FIG. 3B. Each time unit is basically a part of a circle bordered by two neighboring slices.

There are two main embodiments:
(1) the numbers 31 are disposed on said pointer 30 (see for example FIGS. 1A-1C);
(2) the numbers 31 are disposed in said Time Unit.

It is important to note that if the numbers 31 are positioned on said pointer 30 the configuration of said pointer is identical to the configuration of one of said triangles.

It is further important to note that if the numbers 31 are positioned in a Time unit located in each of said triangle, they can follow a spiral pattern of the spiral-like member 20 (as can be seen in FIGS. 1-10); or, they can disposed in or follow any arbitrary configuration (as will be demonstrated in FIG. 11A).

The Display Method

The clock pointers move from left to right. The movement of the clock's pointer from time unit to a second time unit represents the change/progress of time.

The clock pointer could be a line or sequence of numbers (made up from the chosen units of time (hours, minutes, etc.)).

The sequence is made up from numbers, which are placed one on the top of the other. Each number is positioned in the exact height\gap between two neighboring concentric circles and in the width (at the most) of the time unit which it represented by.

According to one embodiment of the present invention, the relevant time unit for representing the time progress will be marked on the surface/board/tablet of the clock. The clock's surface or the display can be provided is a variety of different possibilities: relevant time units are marked, a spirally line that divides the relevant time units from end/edge to end/edge is marked, combining/unifying the same etc. As described above, according to one embodiment the pointer is a numbered pointer, made out from a sequence of numbers, according to the relevant units of time (hours, minutes, etc.).

According to another embodiment the a spirally line is painted on the clock's surface (instead of being an independent/separate element) said line divides the relevant time units from end/edge to end/edge and combine/unify between them by doing so and/or to number the time units with the relevant chosen units of time (hours, minutes, etc.)

According to another embodiment the relevant time-units/time-boxes are painted on the clock's surface.

According to another embodiment the pointer can be a simple clock pointer (i.e., a line). The relevant time-units/time-boxes are marked on the clock's surface/board/tablet. In every time unite there is a display of the relevant unit of time number/measurement.

According to another embodiment the pointer is a simple line and the relevant time-units/time-boxes are marked by the relevant unit of time (number/measurement) are in the same size and position as the equal relevant time-unit/time-box.

According to another embodiment the clock's pointer is static, while the clock surface moves/rotated around said pointer.

Reference is now made again to FIG. 1B which illustrates a watch-face (surface 10) according to one embodiment of the invention, wherein the concentric circles and slices are defined. The time-presenting line (i.e., the spiral curve 20) intersects each of the Time Units and interconnect all of them.

Reference is now made to FIG. 1C which illustrates the same embodiment of the invention, wherein the final watch 100 presentation is displayed. According to another embodiment, the numbering 31 can be disposed on the pointer 30 in a nonconsecutive manner. According to that embodiment the numbering 31 on the pointer 30 will not be sequential (as is illustrated in FIGS. 11D-11F).

According to another embodiment, the numbers 31 which are not sequential ordered on said pointer will be indicated according to their height. Such an embodiment is illustrated in FIGS. 1F-1k.

FIG. 1F illustrate a front view of a watch constructed according to such an embodiment (a pointer in which the numbers 31 are in different heights); FIGS. 1G-1j is a side view of the same. FIGS. 1j-1k is a second example of a watch constructed according to such an embodiment.

Reference is now made to FIGS. 2A-2E which illustrates a watch-face according to a second embodiment of the invention, wherein the Time Units 70 are underlined, e.g., by coloring (see FIGS. 2A and 2B) the Time Units, engraving the same or otherwise defining its shape, borders or perimeters. It should be pointed out that in FIGS. 2A-2E the Time Units 70 follow the spiral like member and create a spiral-like pattern. However, such a configuration is not a must—they can follow any arbitrary configuration (as will be demonstrated in FIG. 11A, 11B-11C).

Reference is now made to FIGS. 2C-2D which illustrates the second embodiment of the invention, wherein the final watch 100 presentation is displayed.

FIG. 2E again illustrates the pointer 30 and the 12 numbers 31 disposed on said pointer.

Both FIGS. 1 and 2 discloses a specific embodiment wherein the pointers (indicators) are presented as numbers (e.g., 1 o'clock, 12 o'clock etc); however, Notes, keys, letters, colors, symbols etc. are also possible.

Reference is now made to FIGS. 3A-3C which illustrates a watch-face according to third embodiment of the invention.

FIG. 3A illustrates the pointer 30 according to this embodiment. In said embodiment it can be seen that the pointer does not contain the set of numbers but is a simple line.

FIG. 3B illustrates the surface 10 upon which the spiral-like member 20 is disposed. According to this embodiment the spiral-like member comprises the set of numbers 31 which eventually represents the time (i.e., the hours, minutes or seconds). In this embodiment the numbers 31 are each located in a time unit on the surface 10.

As described above, the positioning of the numbers 31 (i.e., the position of each time unit) is pre-calculated:

After the surface 10 had been ‘sliced’ and the circles have been drawn on the same (in FIG. 3B there are 12 circles and 12 slices), n triangles are created (see numerical reference 80 in FIGS. 2A, 3B). n equals the number of circles and slices. In FIG. 3B 12 triangles are created.

Each triangle 80 comprises n cells (refers as Time units). Each time unit is basically a part of a circle bordered by two neighboring slices.

According to said embodiment, each number (31) is positioned in one of said n Time units. It is important to note that the numbers 31 which are positioned in a Time unit located in said triangle can follow a spiral pattern of the spiral-like member 20 (as can be seen in FIGS. 3B-3C) however it can disposed in an arbitrary configuration (as will be demonstrated in FIG. 11A-11C).

FIG. 3C, illustrates the final watch 100 presentation is displayed. Here, the time is 11. It is in the scope of the invention wherein each of the Time Units are interchangeable, i.e., one may reversibly change e.g., 12 O'clock with e.g., 4 O'clock.

This is especially important in interchanging the values of the Time Units in the aforesaid spiral time line in moving from one time zone to a second time zone (e.g., east coast vs. west cost).

FIG. 4 illustrates a front view of one of the embodiments provided by the present invention. FIG. 5 illustrates a back view of one of the embodiments provided by the present invention.

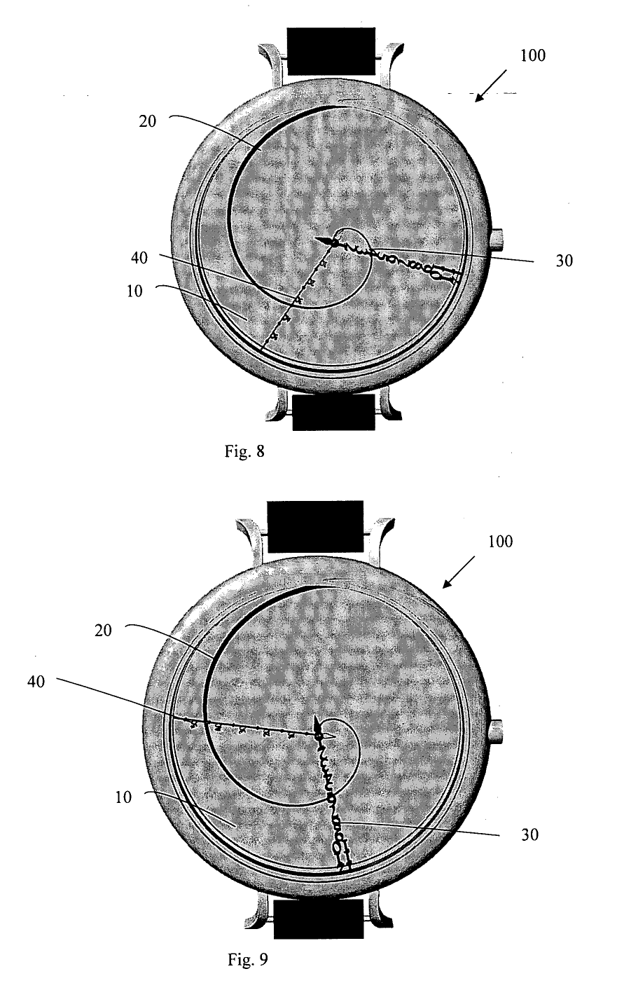

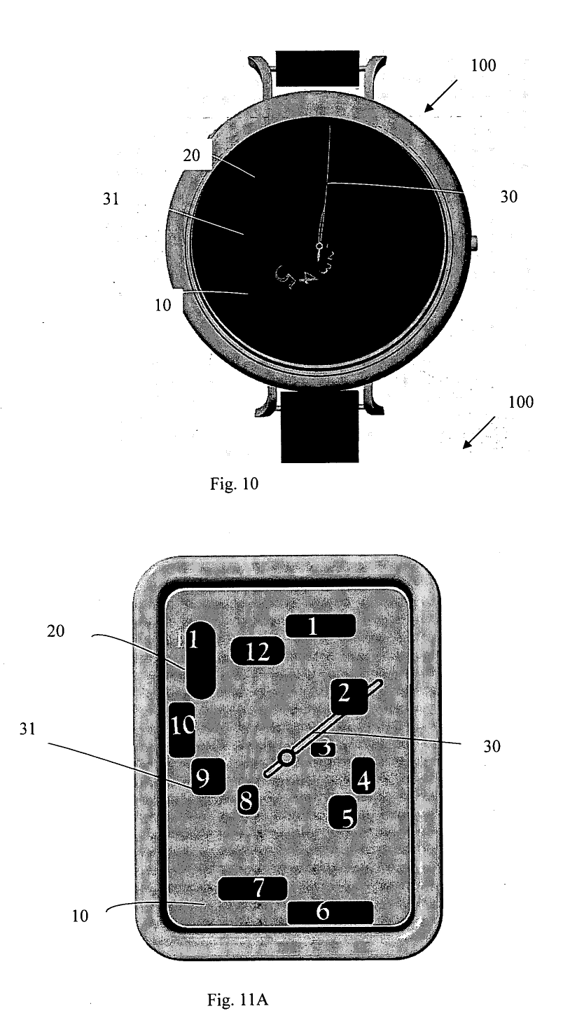

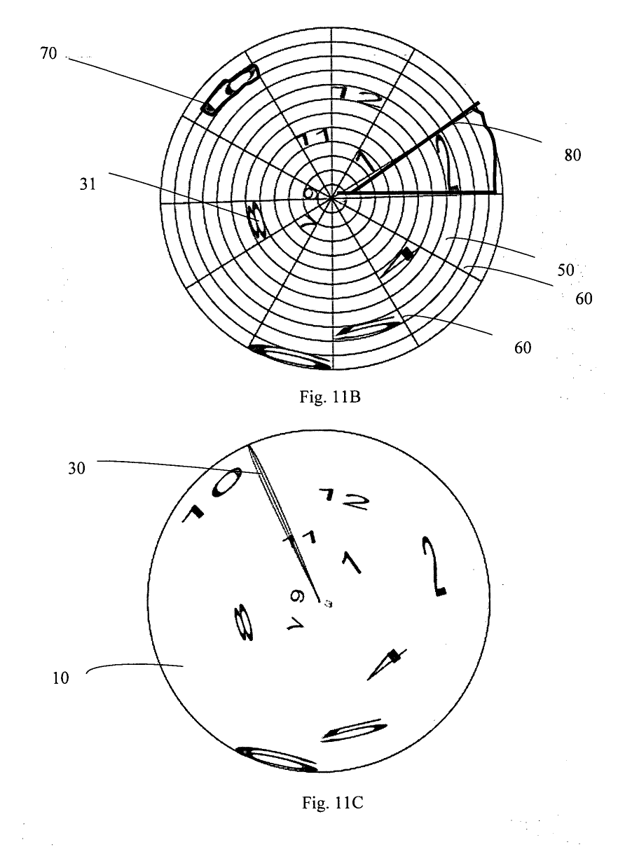

Reference is now made to FIG. 6 which illustrate a watch 100 in which 2 pointers (30 and 40) are utilized (one represents the hours and the other represents the seconds). The time represented in FIG. 6 is 12:15. Reference is now made to FIG. 7 which illustrate a watch 100 in which 2 pointers (30 and 40) are utilized (one represents the hours and the other represents the seconds). The time represented in FIG. 7 is 1:20. Reference is now made to FIG. 8 which illustrate a watch 100 in which 2 pointers (30 and 40) are utilized (one represents the hours and the other represents the seconds). The time represented in FIG. 8 is 4:35. Reference is now made to FIG. 9 which illustrate a watch 100 in which 2 pointers (30 and 40) are utilized (one represents the hours and the other represents the seconds). The time represented in FIG. 9 is 6:45. Reference is now made to FIG. 10 which illustrate a watch 100 in which the pointer (30) does not contain the numbers (which eventually represent the time), but the spiral like member 20 contains the numbers 31. The time represented in FIG. 10 is 10:00. Reference is now made to FIG. 11A which illustrate a watch in which the pointer (30) does not contain the numbers (which eventually represent the time). The time represented in FIG. 11 is 2:00.

FIG. 11A illustrates an important feature in which the numbers 31 are not disposed neither on the pointer (30). FIG. 11 further illustrates that the numbers 31 do not follow the spiral-like pattern, but are positioned in an arbitrary manner. I.e., the pre-shaped member 20 is not configured as a spirally shaped but as an arbitrary-like shaped.

In this embodiment, numbers 31 (each of which located in a time unit 70 which is disposed in a different triangle 80) create an arbitrary pattern to said pre-shaped member 20.

Reference is now made to FIGS. 11B-11C in which an arbitrary pattern of the numbers 31 on the surface 10 is demonstrated.

FIG. 11B again illustrates the division of the surface 10 to the n slices 60 and n concentric circles 50; hence to the n triangles 80, each of which contains n Time Units 70. n being 12.

Again the numbers 31 are disposed in an arbitrary pattern. i.e., the shaped of the pre-shaped member 20 is arbitrary.

FIG. 11C illustrate the final configuration of FIG. 11B (i.e., without the slices and the concentric cycles) combined with the pointer 30.

Therefore, it is another object of the present invention to enable measurement of a measurable parameter (e.g., time) by dividing the surface twice (into n circles and n slices, thereby obtaining n triangles) and then positioning the appropriate numbering 31 in any desired location within at least one of said triangles.

The numbering 31 can follow any pre-calculated pattern (e.g., spiral, as can be seen in FIGS. 1-10) or any arbitrary pattern (as can be seen in FIG. 11A-11C).

Reference is now made to FIGS. 11D-11F in which the numbering 31 on the pointer 30 are not sequential.

FIG. 11D illustrates the pointer with the non-sequential numbers 31.

In light of the non-sequentially positioning of the numbers 31 on the pointer 30, the pattern/shape of the pre-shaped member 20 is arbitrary as well so as to provide the correct intersection that will eventually provide the correct measurement:

For instance, in FIG. 11D the number 9 is located in the second circle on the pointer, hence a time unit 70a in the second circle on the surface will be highlighted. When the number 9 on the pointer will intersect with said time unit 70a—the time would be 9.

As a second example we will examine the number 10. The number 10 is located in the 11^{th} circle on the pointer, hence a unit time 70b in the 11^{th} circle on the surface will be highlighted. When the number 10 on the pointer will intersect with said time unit 70b—the time would be 10.

FIG. 11F illustrate the complete watch combined pointer and the pre-shaped member 20. The hour illustrated in FIG. 11F is 11 (encircled).

It should be emphasized that the present invention does not relates merely to watches and displays, but it constitutes a technique/method of visually calculating any numerical value. For example and according to another embodiment of the present invention the calculation method can measure time, temperature (i.e., it can be used as a thermostat), quantities measurements (weight, mass), pressure measurements (e.g., liquids such as liquids, oils etc.), altitude measurements (e.g., in flights or diving), intensity (e.g., Richter scale).

The display can be a mechanic display or a digital display (e.g., in a cell phone, computers etc.) in a 2 dimensional or 3 dimensional display.

According to one embodiment of the present invention, the measurable parameter or the measurable parameter's units are selected from a group consisting of digits, letters, words, figures, symbols et cetera.

According to another embodiment of the present invention, the measurable units are presented on either the board/surface or the pointer.

According to another embodiment of the present invention, the board can in any shape selected from any geometric shape, amorphous shape.

One example of a liquid measuring instrument is given in FIGS. 12A-12C. Reference is now made to FIG. 12A illustrating the pointer 30 upon which the representative quantities numbers 31 are given. In this example, the numbers 31 represents fluid measurements indicatives (e.g., ¼, ½, ¾ et cetera).

Reference is now made to FIG. 12B illustrating the surface 10 of the measuring instrument 100. FIG. 12B also illustrates the spiral-like member 20.

FIG. 12C illustrate the entire measuring instrument 100 comprising both the pointer and the spiral-like member.

FIGS. 12A-12C illustrate another feature of the present invention, in which only a portion of the concentric/coaxial circles are used. In which case half a circle is used. It should be pointed out that ¼, 11/13, ⅞, ⅓ et cetera circle can be used.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1-78. (canceled)

79. A measuring instrument 100 for measuring and displaying a measurable parameter, said measuring instrument having at least one surface 10, said surface comprising:
a. at least one elongated pointer 30 characterized by a main longitudinal axis having a distal end and a proximal end; said pointer is pin to said surface in either said distal end or said proximal end; said pointer comprises a set of n symbols 31 disposed along said main longitudinal axis; said n is an integer greater than or equals to 0;
b. a pre-shaped member 20 characterized by a predetermined curvature;
c. means adapted to constantly rotate said elongated pointer around said pre-shaped member on said surface or said pre-shaped member around said elongated pointer;
wherein said measurable parameter is defined as said n^{th} symbol in which an intersection between said pointer with said pre-shaped member is provided.

80. The measuring instrument according to claim 79, wherein at least one of the following is being held true (a) said pre-shaped member 20 is characterized by a spiral-like shaped, arbitrary shape, circle-like shape, square shape or any combination thereof; (b) said measurable parameter is selected from a group consisting of time, temperature, quantities measurements (weight, mass), pressure measurements, altitude measurements, intensity or any combination thereof; (c) said measuring instrument is selected from a group consisting of watch, time keeping device, thermostat, weight, pressure gauge, barometer, altimeter or any combination thereof; (d) said pre-shaped member 20 is embedded within said surface 10; and any combination thereof.

81. The measuring instrument according to claim 79, wherein at least one of the following is being held true (a) said displaying is selected from a group consisting of a mechanical display, digital display in either a 2 dimensional or 3 dimensional display or any combination thereof; (b) said symbol is selected from a group consisting of digits, letters, words, figures or any combination thereof; (c) said means are adapted to constantly rotate said pre-shaped member embedded within said surface around said elongated pointer; (d) the shape of said surface is selected from a group consisting of any geometrical shape, amorphous shape or any combination thereof.

82. The measuring instrument according to claim 79, wherein at least one of the following is being held true (a) said n symbols are interchangeable such that the position of each symbols is altered; (b) said n symbols are selected from a group consisting of integer numbers, real numbers, chars, strings or any combination thereof; (c) said n symbols are integers; (d) said n symbols are positioned on said pointer in either a sequential or a non sequential manner; and any combination thereof.

83. A method for measuring a measurable parameter, said method comprising steps of:
a. obtaining a measuring instrument 100 having at least one surface, said surface 10 comprising at least one pointer and at least one pre-shaped member 20;
b. identifying the intersection point between said pointer and said pre-shaped member;
c. defining said measurable parameter as said n^{th} symbol in said intersection; thereby measuring said measurable parameter.

84. The method according to claim 83, wherein said step of obtaining a measuring instrument 100 additionally comprising step of providing said measuring instrument 100 with:
a. at least one elongated pointer 30 characterized by a main longitudinal axis having a distal end and a proximal end; said pointer is pin to said surface in either said distal end or said proximal end; said pointer comprises a set of n symbols 31 disposed along said main longitudinal axis; said n is an integer greater than or equals to 0;
b. a pre-shaped member 20 characterized by a predetermined curvature; and,
c. means adapted to constantly rotate said elongated pointer around said pre-shaped member on said surface or said pre-shaped member around said elongated pointer.

85. The method according to claim 83, wherein said step of obtaining a measuring instrument 100 additionally comprising step of providing said measuring instrument 100 with:
a. at least one pre-shaped member 20 characterized by a predetermined curved shape; said pre-shaped member is pined to said surface; said pre-shaped member comprises a set of n symbols 31 disposed along said curved shape; said n is an integer greater than or equals to 0;
b. at least one elongated pointer 30 characterized by a main longitudinal axis; and,
c. means adapted to constantly rotate said elongated pointer around said pre-shaped member 20 on said surface 10 or said pre-shaped member around said elongated pointer.

86. The method according to claim 83, additionally comprising at least one step selected from a group consisting of (a) selecting said measurable parameter from a group consisting of time, temperature, quantities measurements (weight, mass), pressure measurements, altitude measurements, intensity or any combination thereof; (b) selecting said measuring instrument from a group consisting of watch, time keeping device, thermostat, weight, pressure gauge, barometer, altimeter or any combination thereof; and any combination thereof.

87. The method according to claim 83, additionally comprising at least one step selected from a group consisting of (a) displaying said measurable parameter; (b) selecting said displaying from a group consisting of a mechanical display, digital display in either a 2 dimensional or 3 dimensional display or any combination thereof; (c) selecting said symbol from a group consisting of digits, letters, words, figures or any combination thereof; (d) embedding said pre-shaped member 20 within said surface 10; (e) constantly rotating said pre-shaped member embedded within said surface around said elongated pointer; (f) constantly rotating said elongated pointer around said pre-shaped member on said surface around; and any combination thereof.

88. The method according to claim 83, additionally comprising at least one step selected from a group consisting of (a) interchanging said n symbols such that the position of each symbols is altered; (b) selecting said n symbols from a group consisting of integer numbers, real numbers, chars, strings or any combination thereof; (c) positioning said n symbols on said pointer in either a sequential or a non sequential manner; (d) selecting the shape of said pre-shaped member 20 from a group consisting of spiral-like shaped, arbitrary shape, circle-like shape, square shape or any combination thereof; and any combination thereof.

89. A measuring instrument 100 for measuring and displaying a measurable parameter, said measuring instrument having at least one surface 10, said surface comprising:
a. at least one pre-shaped member 20 characterized by a predetermined curved shape; said pre-shaped member is pined to said surface; said pre-shaped member comprises a set of n symbol 31 disposed along said curved shape; said n is an integer greater than or equals to 0;
b. at least one elongated pointer 30 characterized by a main longitudinal axis;
c. means adapted to constantly rotate said elongated pointer around said pre-shaped member 20 on said surface 10 or said pre-shaped member around said elongated pointer;
wherein said measurable parameter is defined as said n^{th} symbol in which an intersection between said pointer with said pre-shaped member is provided.

90. The measuring instrument according to claim 89, wherein at least one of the following is being held true (a) said measurable parameter is selected from a group consisting of time, temperature, quantities measurements (weight, mass), pressure measurements, altitude measurements, intensity or any combination thereof; (b) said measuring instrument is selected from a group consisting of watch, time keeping device, thermostat, weight, pressure gauge, barometer, altimeter or any combination thereof; (c) said displaying is selected from a group consisting of a mechanical display, digital display in either a 2 dimensional or 3 dimensional display or any combination thereof; (d) said pre-shaped member 20 is characterized by a spiral-like shaped, arbitrary shape, circle-like shape, square shape or any combination thereof; and any combination thereof.

91. The measuring instrument according to claim 89, wherein at least one is being held true (a) said symbol is selected from a group consisting of digits, letters, words, figures or any combination thereof; (b) said pre-shaped member 20 is embedded within said surface 10; (c) said means are adapted to constantly rotate said pre-shaped member embedded within said surface around said elongated pointer and any combination thereof.

92. The measuring instrument according to claim 89, wherein at least one of the following is being held true (a) said n symbols are interchangeable such that the position of each symbols is altered; (b) said n symbols are selected from a group consisting of integer numbers, real numbers, chars, strings or any combination thereof; (c) said n symbols are integers; (d) n symbols are positioned on said pointer in either a sequential or a non sequential manner; and any combination thereof; (e) the shape of said surface is selected from a group consisting of any geometrical shape, amorphous shape or any combination thereof.

93. A time keeping device 100 for displaying the time having at least one surface 10, said surface comprising:
a. at least one elongated pointer 30 characterized by a main longitudinal axis having a distal end and a proximal end; said pointer is pin to said surface in either said distal end or said proximal end; said pointer comprises a set of at least 12 numbers 31 disposed along said main longitudinal axis; each of said numbers represents parameters selected from a group consisting of hours, minutes, seconds or any combination thereof;
b. at least one pre-shaped member 20 characterized by a predetermined curvature;
c. means adapted to constantly rotate said elongated pointer around said static pre-shaped member on said surface or said pre-shaped member around said elongated pointer;
wherein said time is calculated from the intersection of said pointer with said pre-shaped member.

94. The time keeping device according to claim 93, wherein at least one of the following is being held true (a) the shape of said surface is selected from a group consisting of any geometrical shape, amorphous shape or any combination thereof; (b) said pre-shaped member 20 is characterized by a spiral-like shaped, arbitrary shape, circle-like shape, square shape or any combination thereof; (c) said numbers 31 are positioned on said pointer in either a sequential or a non sequential manner; (d) said pre-shaped member 20 is embedded within said surface 10; (e) said means are adapted to constantly rotate said pre-shaped member embedded within said surface around said elongated pointer.

95. The time keeping device according to claim 93, wherein at least one of the following is being held true (a) said pre-shaped member 20 is embedded within said surface 10; (b) said means are adapted to constantly rotate said pre-shaped member embedded within said surface around said elongated pointer; (c) said n numbers are interchangeable such that the position of each symbols is altered; (d) said displaying is selected from a group consisting of a mechanical display, digital display in either a 2 dimensional or 3 dimensional display or any combination thereof; and any combination thereof.

96. A time keeping device 100 for displaying the time having at least one surface 10, said surface comprising:
a. at least one pre-shaped member 20 characterized by a predetermined curved shape; said pre-shaped member is pined to said surface; said pre-shaped member comprises a set of at least 12 numbers 31 disposed along said curved shape; each of said numbers represents parameters selected from a group consisting of hours, minutes, seconds or any combination thereof;
b. at least one elongated pointer 30 characterized by a main longitudinal axis;
c. means adapted to constantly rotate said elongated pointer around said pre-shaped member on said surface 10 or said pre-shaped member around said elongated pointer;
wherein said time is calculated from the intersection of said pre-shaped member with said pointer.

97. The time keeping device according to claim 96, wherein at least one of the following is being held true (a) the shape of said surface is selected from a group consisting of any geometrical shape, amorphous shape or any combination thereof; (b) said pre-shaped member 20 is characterized by a spiral-like shaped, arbitrary shape, circle-like shape, square shape or any combination thereof; (c) said pre-shaped member 20 is embedded within said surface 10; and any combination thereof.

98. The time keeping device according to claim 96, wherein at least one of the following is being held true (a) said means are adapted to constantly rotate said pre-shaped member embedded within said surface around said elongated pointer; (b) said means are adapted to constantly rotate said pre-shaped member embedded within said surface around said elongated pointer; (c) said numbers are interchangeable such that the position of each symbols is altered; (d) said numbers are positioned on said pointer in either a sequential or a non sequential manner; and any combination thereof; (e) said displaying is selected from a group consisting of a mechanical display, digital display in either a 2 dimensional or 3 dimensional display or any combination thereof; (f) said pre-shaped member 20 is embedded within said surface 10; and any combination thereof.
